(19) United States
(12) Patent Application Publication
(10) Pub. No.: US 2015/0293972 A1
(43) Pub. Date: Oct. 15, 2015

(54) METHOD AND DEVICE USED FOR PROVIDING INPUT CANDIDATE ITEMS CORRESPONDING TO AN INPUT CHARACTER STRING

(71) Applicant: Baidu Online Network Technology (Beijing) Co., Ltd., Beijing (CN)

(72) Inventors: Yangyang Lu, Shanghai (CN); Kefeng Meng, Shanghai (CN)

(21) Appl. No.: 14/412,287

(22) PCT Filed: Nov. 12, 2013
(86) PCT No.: PCT/CN2013/086968

§ 371 Date: Dec. 31, 2014

(30) Foreign Application Priority Data
Dec. 31, 2012 (CN) 201210592774.9

(51) Int. Cl. G06F 17/30

(52) U.S. Cl. CPC G06F 17/30477; G06F 17/30554

(57) ABSTRACT

An input device for providing input candidate items corresponding to an input character string includes an obtaining module configured to obtain an input character string, a context determining module configured to determine context information of the input character string, a candidate items determining module configured to determine one or more input candidate items corresponding to the input character string based on the input character string and the context information, and a providing module configured to provide at least one of the one or more input candidate items to a target application corresponding to the input character string.

### CROSS REFERENCE TO RELATED APPLICATIONS

This application is the U.S. national stage under 35 USC 371 of international application PCT/CN2013/086968, filed on Nov. 12, 2013, which claims the benefit of the Dec. 31, 2012 priority date of Chinese application 201210592774.9. The contents of all the foregoing are herein incorporated by reference.

### FIELD OF THE INVENTION

The present invention relates to the field of Internet, and in particular to the technology for providing input candidate items corresponding to an input character string.

### BACKGROUND OF THE INVENTION

For Chinese input, there are a considerable number of homonyms; however, in actuality, a user only selects one of them during the input process. The current input method provides a plurality of input candidate items to the user, who makes selection according to the actual needs. When there are many input candidate items, the user's selecting operation will cause the input slow and inefficient. Considering there is a certain semantic or logical relationship between inputs of characters, it becomes an issue imminent to be solved by those skilled in the art that how to process the input candidate items using the semantic or logical relationships so as to improve the user experience.

### SUMMARY OF THE INVENTION

An object of the invention is providing a method and a device for providing input candidate items corresponding to an input character string.

According to one aspect of the invention, a method for providing input candidate items corresponding to an input character string is provided, wherein the method comprises the following steps:

a. obtaining an input character string;

b. determining context information of the input character string;

c. determining one or more input candidate items corresponding to the input character string based on the input character string and the context information;

d. providing at least one of the one or more input candidate items to a target application corresponding to the input character string.

According to another aspect of the invention, an input device for providing input candidate items corresponding to an input character string is further provided, wherein the device comprises:

an obtaining module configured to obtain an input character string;

a context determining module configured to determine context information of the input character string;

a candidate items determining module configured to determine one or more input candidate items corresponding to the input character string based on the input character string and the context information;

a providing module configured to provide at least one of the one or more input candidate items to a target application corresponding to the input character string.

Compared with the prior art, the present invention determines one or more input candidate items corresponding to the input character string based on the context information of the input character string, and provides at least one of the one or more input candidate items to a target application corresponding to the input character string; thereby, the present invention enhances the input flexibility, meets the user's input needs, enhances the input efficiency of the input method, and improves user experience.

Moreover, the present invention may process the one or more preliminary input candidate items corresponding to the input character string, so as to obtain the one or more input candidate items; furthermore, the present invention may further process the one or more preliminary input candidate items based on collocation relevancy information between the preliminary input candidate items and the corresponding context information, so as to obtain the one or more input candidate items; furthermore, the present invention may perform analysis processing to text information to obtain a word segmentation collocation relationship whose collocation frequency satisfies a certain threshold, so as to establish or update the word collocation database. Thereby, the present invention enhances the match accuracy between the input character string and the input candidate items, meets the user's input needs, enhances the input efficiency of the input method, and improves user experience.

Moreover, the present invention may determine a supplementary character string including the input character string, and obtains one or more supplementary input candidate items corresponding to the supplementary character string based on the supplementary character string, then, performs screening processing to the supplementary input candidate items to obtain the one or more input candidate items. Thereby, the present invention enhances the input flexibility, enhances the match accuracy between the input character string and the input candidate items, meets the user's input needs, enhances the input efficiency of the input method, and improves user experience.

Moreover, the present invention may extract a corresponding focal word as the context from a relevancy text by performing natural language processing to the relevancy text corresponding to the input character string, thereby enhancing the match accuracy between the input character string and the input candidate items, meeting the user's input needs, enhancing the input efficiency of the input method, and improving user experience.

Moreover, the present invention may detect whether the input character string has exceeded a predetermined length threshold, if the input character string exceeds the length threshold, iteratively determine one or more input candidate items corresponding to the input character string based on the input character string and the context information; furthermore, detect whether the number of words of at least one of the one or more sample input candidate items which corresponds to the input character string in an input lexicon has exceeded a predetermined threshold of the number of words, to determine whether the input character string exceeds a predetermined length threshold; furthermore, when the input character string exceeds the length threshold, determine partial input candidate items and remaining input candidate items, and determine the one or more input candidate items based on the one or more partial input candidate items and the one or more remaining input candidate items. Thereby, the present invention enhances the input flexibility, enhances the match accuracy between the input character string and the input candidate items, meets the user's input needs, enhances the input efficiency of the input method, and improves user experience.

### BRIEF DESCRIPTION OF THE DRAWINGS

Other features, purposes and advantages of the invention will become more explicit by means of reading the detailed statement of the non-restrictive embodiments made with reference to the accompanying drawings.

FIG. 1 shows a schematic diagram of the input device for providing input candidate items corresponding to an input character string according to one aspect of the present invention;

FIG. 2 shows a schematic diagram of the input device for providing input candidate items corresponding to an input character string according to one preferred embodiment of the present invention;

FIG. 3 shows a schematic diagram of the input device for providing input candidate items corresponding to an input character string according to another preferred embodiment of the present invention;

FIG. 4 shows a flow diagram of a method for providing input candidate items corresponding to an input character string according to another aspect of the present invention;

FIG. 5 shows a flow diagram of a method for providing input candidate items corresponding to an input character string according to one preferred embodiment of the present invention;

FIG. 6 shows a flow diagram of a method for providing input candidate items corresponding to an input character string according to another preferred embodiment of the present invention.

The same or similar reference signs in the drawings represent the same or similar component parts.

### DETAILED DESCRIPTION OF THE INVENTION

Below, details of the invention will be further provided in combination with the accompanying drawings.

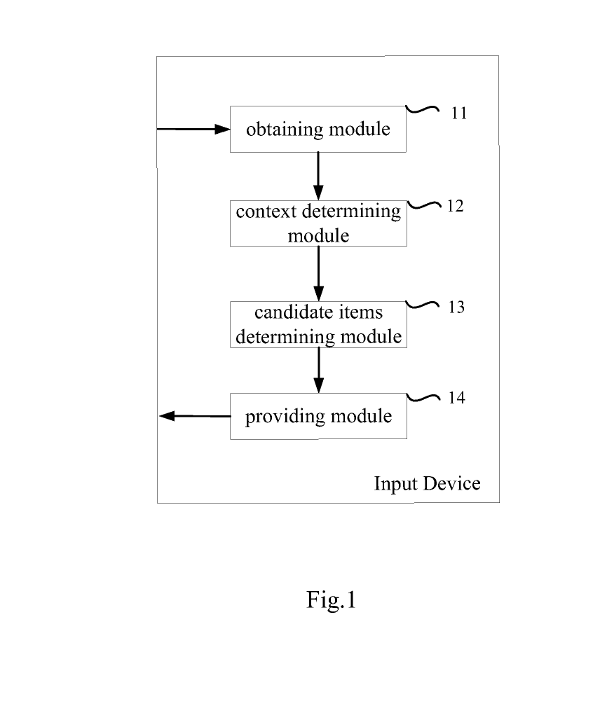

FIG. 1 shows a schematic diagram of the input device for providing input candidate items corresponding to an input character string according to one aspect of the present invention; wherein, the input device comprises an obtaining module 11, a context determining module 12, a candidate items determining module 13, a providing module 14. Specifically, the obtaining module 11 obtains an input character string; the context determining module 12 determines context information of the input character string; the candidate items determining module 13 determines one or more input candidate items corresponding to the input character string based on the input character string and the context information; the providing module 14 provides at least one of the one or more input candidate items to a target application corresponding to the input character string. Here, the input device includes, but not limited to, network device, user device or a device integrated network device(s) and user device(s) through a network. Here, the network device includes, but not limited to, personal computer(s), network host(s), single network server, a set of multiple network servers or a cloud network formed by multiple servers; herein, the cloud network is formed by a large number of computers or network servers based on Cloud Computing, wherein, the cloud computing is a kind of distributed computing, which is a virtual supercomputer consisting of a group of loosely coupled computers set. The user device includes, but not limited to, any electronic product could process man-machine interaction with the user through keyboard, remote-control unit, touch panel, or acoustic equipment, such as personal computers, smart phones, PDAs, game consoles, or IPTV and so on. The network includes, but not limited to, the Internet, Wide Area Network, Metropolitan Area Network, LAN, VPN, wireless self-organizing network (Ad Hoc network), etc. Those skilled in the art should understand that other input device, if applicable to the present invention, should also be included within the protection scope of the present invention and are incorporated here by reference.

The above modules work constantly therebetween. Here, those skilled in the art should understand that “constantly” means the above various modules perform obtaining an input character string, determining context information, determining input candidate items, providing input candidate items and etc. respectively in real-time or according a preset or real-time adjusted working pattern requirements, until the input device stops obtaining an input character string.

The obtaining module 11 obtains an input character string. Specifically, the obtaining module 11 receives a character string inputted by the user or other applications through operations such as input, select, click and the like from the input box; or based on various communication protocols via various data transmission interfaces, obtains a character string from within an input box of other applications; wherein the input box is such as an SMS editing box, content input box, etc. Here, the input character string includes, but not limited to, pinyin coded characters and the like inputted by full pinyin or simplified pinyin and the like.

The context determining module 12 determines context information of the input character string. Specifically, the context determining module 12 matches the words to which the current input character string belongs with one or more lexicons using the words to which the currently inputted character string belongs based on the input character string obtained by the obtaining module 11, and obtains one or more kind of matching information associated with the input character string as the context information of the input character string; for example, when inputting “huacao”, it is first determined that the words to which the input character string belongs are likely “ [symbol] (flower and grass),” and based on the matching information of “ [symbol] ” in the lexicon, it is determined that its context information could be “ [symbol] (tea),” and the like; or, the context determining module 12 determines the context information of the input character string based on the historical record information corresponding to the input character string, e.g., the preceding input character string just displayed on the screen before the present input character string may be used as the previous context information of the input character string. Herein, the context information includes, but not limited to, preceding context information or subsequent context information corresponding to the input character string; for example, when the input is “shishi,” and when the phrase displayed on the screen for the preceding input is “ [symbol] (objective),” then the preceding context information corresponding to the “shishi” is “ [symbol] ”; if the screen presents a phrase “ [symbol] (plan)” and when “shishi” is input, the cursor is positioned before “ [symbol] ” then the corresponding subsequent context information is “ [symbol] ”.

The candidate items determining module 13 determines one or more input candidate items corresponding to the input character string based on the input character string and the context information. Specifically, the candidate items determining module 13 determines one or more input candidate items corresponding to the input character by directly using one or more pieces of context information corresponding to the input character string as one or more input candidate items based on the input character string obtained by the obtaining module 11 and the context information determined by the context determining module 12, or using the processed context information corresponding to the input character string as the input candidate items. For example, following the above example, when the input character string is “shishi”, its corresponding preceding context information could be “ [symbol] ”, “ [symbol] (I)”, “ [symbol] (discuss)”, etc.; when the preceding context information is “ [symbol] ”, it is determined that the input candidate items are “ [symbol] (fact)”, “ [symbol] (real-time)”, “ [symbol] (implement)”, and the like by the manner of matching the input character string and the context information matching; when the preceding context information is “ [symbol] ”, it is determined that the input candidate items are “ [symbol] (try)”, “ [symbol] [symbol] (implement)”, “ [symbol] (try)”, and the like; when the preceding context information is “ [symbol] (discuss)”, it is determined that the input candidate items are “ [symbol] (current events)”, “ [symbol] (facts)”, “ [symbol] (things of the world)”, and the like.

The providing module 14 provides at least one of the one or more input candidate items to a target application corresponding to the input character string. Specifically, the providing module 14 provides at least one of the one or more input candidate items to a target application corresponding to the input character string directly or based on various communication protocols with various data transfer interfaces through re-ordering or screening as an example, wherein the target application includes, but not limited to, the same application corresponding to an input box corresponding to the obtaining module 11, or other application associated with the input box corresponding to the obtaining module 11, e.g., performing search directly using the input candidate item, etc.

Preferably, the candidate items determining module 13 may determine a supplementary character string including the input character string based on the input character string and the context information, wherein the supplementary character string further comprises a character string corresponding to the context information; perform match query in an input lexicon based on the supplementary character string to obtain one or more supplementary input candidate items corresponding to the supplementary character string; and perform screening processing to the one or more supplementary input candidate items based on the context information to obtain the one or more input candidate items. Specifically, the candidate items determining module 13 may also determine a supplementary character string including the input character string based on the input character sting and the context information by matching the input character string in combination with the context information to for example the input lexicon. For example, when the input character string is “xuxu” and the context information is “ [symbol] (shape),” then it is determined that the supplementary character string is “rusheng”; or, when the input character string is “tianan” and the context information is “ [symbol] (Beijing),” then it is determined that the supplementary character string is “men.” Here, the supplementary character string includes, but not limited to, one or more multi-segment character strings formed by joining which determined by matching. The candidate items determining module 13 obtains one or more supplementary input candidate items corresponding to the supplemental character strings by performing a match query for the supplementary character string in the input lexicon. Following the above example, when the supplementary character string is “rusheng” and the corresponding supplementary input candidate items are, for example, “ [symbol] (ru'sheng, vivid),” “ [symbol] (ru'sheng, the fourth tone in Chinese pronunciation),” “ [symbol] (ru'sheng, fascinating),” and the like; when the supplementary character string is “men,” the corresponding supplementary input candidate items are “ [symbol] (tian an men),” “ [symbol] (men, gate),” etc. Or, the supplementary input candidate item may also directly comprise the context information, e.g., directly generating “ [symbol] (the shape is vivid),” “ [symbol] (Beijing Tian'an Men),” and the like. Based on the context information, the one or more supplementary input candidate items are subject to screening processing. Following the above example, based on the context information, the input candidate items are determined to “ [symbol] ,” “ [symbol] ,” respectively, thereby obtaining one or more input candidate items; here, if the supplementary input candidate items comprise context information, then after the context information in the supplementary input candidate item is deleted, one or more input candidate items are obtained. For example, if “ [symbol] ” in the supplementary input candidate item “ [symbol] [symbol] ” is deleted, one or more input candidate items, i.e., “ [symbol] ,” are obtained.

Preferably, the context determining module 12 may extract a corresponding focal word as the context from a relevancy text by performing natural language processing to the relevancy text corresponding to the input character string, wherein the focal word is adjacent to an input position corresponding to the input character string. Specifically, the context determining module 12 may also perform natural language processing to relevant text corresponding to the input character string by segmentation or semantic analysis, wherein the relevant text includes, but not limited to, the text corresponding to the input character string per se, or relevant text that has been displayed on the screen before/after the input position corresponding to the input character string; by performing natural language processing to the relevant text, corresponding focal words are extracted as the context. For example, when the input character string is “shishi”, its corresponding relevant text is “ [symbol] (Shanghai metro first-stage project)”, and the input character string is located after “ [symbol] ”, and by performing natural language processing to the relevant text, the focal word as extracted is “ [symbol] (project)”, which is used as the context. Further, when the input character string is “shishi”, the input device determines, based on the context “project”, that the input candidate items are “ [symbol] [symbol] (shishi, implement)”, “ [symbol] (shishi, real-time)”, and “ [symbol] (shishi, try)”, etc.

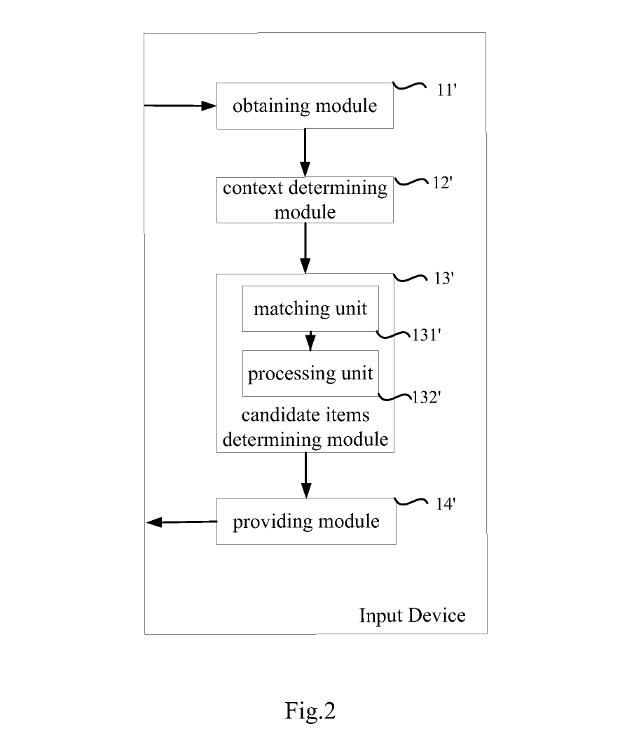

FIG. 2 shows a schematic diagram of the input device for providing input candidate items corresponding to an input character string according to one preferred embodiment of the present invention; wherein, the input device comprises an obtaining module 11′, a context determining module 12′, a candidate items determining module 13′, a providing module; here, the candidate items determining module 13′ comprises a matching unit 131′ and a processing unit 132′. Specifically, the obtaining module 11′ obtains an input character string; the context determining module 12′ determines context information of the input character string; the matching unit 131′ performs match query in an input lexicon based on the input character string, so as to obtain one or more preliminary input candidate items corresponding to the input character string; the processing unit 132′ processes the one or more preliminary input candidate items based on the context information, so as to obtain the one or more input candidate items; the providing module 14′ provides at least one of the one or more input candidate items to a target application corresponding to the input character string. Herein, the obtaining module 11 ‘, the context determining module 12’, the providing module 14′ are identical or substantially identical to corresponding modules shown in FIG. 1, which are thus not detailed here, but incorporated here by reference.

The above modules work constantly therebetween. Here, those skilled in the art should understand that “constantly” means the above various modules perform obtaining an input character string, determining context information, obtaining preliminary input candidate items, determining input candidate items, providing input candidate items and etc. respectively in real-time or according a preset or real-time adjusted working pattern requirements, until the input device stops obtaining an input character string.

The matching unit 131′ performs match query in an input lexicon based on the input character string, so as to obtain one or more preliminary input candidate items corresponding to the input character string. Specifically, the matching unit 131′ matches the input character string with words in the input lexicon by obtaining the input character string, so as to obtain one or more preliminary input candidate items corresponding to the input character string. For example, when the input character string is “shishi”, after performing match query in the input lexicon, a plurality of preliminary input candidate items such as “ [symbol] (shishi, real-time)”, “ [symbol] (shishi, try)”, “ [symbol] (shishi, implement)”, “ [symbol] (shishi, fact)”, “ [symbol] (shishi, at appropriate time)”, “ [symbol] (shishi, deceased)”, and etc. are obtained.

The processing unit 132′ processes the one or more preliminary input candidate items based on the context information, so as to obtain the one or more input candidate items. Specifically, the processing unit 132′ determines a collocation probability between the context information and the preliminary input candidate items based on the context information of the input character string through a natural language model or a word collocation database, etc., and performing screening or ordering to the preliminary input candidate items based on the collocation probability, to obtain the input candidate items. For example, following the above example, when the context information is “ [symbol] (objective)”, then after processing, through reordering the preliminary input candidate items, the order changes to be “ [symbol] (shishi, fact)”, “ [symbol] (shishi, real-time)”, “ [symbol] (shishi, try)”, “ [symbol] (shishi, implement)”, “ [symbol] (shishi, at appropriate time)”, “ [symbol] (shishi, deceased)”, and etc.

Preferably, the processing unit 132′ may perform match query in a word collocation database based on the context information to determine collocation relevancy information between the preliminary input candidate items and the corresponding context information; and process the one or more preliminary input candidate items based on the collocation relevancy information to obtain the one or more input candidate items. Specifically, the processing unit 132′ may also perform matching query in the word collocation database based on the context information, to determine the collocation relevancy information between the preliminary input candidate items and the corresponding context information based on the matching relationship between the one or more entries in the word collocation database and the context; for example, if it is a bull variable, then the collocation relevancy information indicates if a collocation exists; if it is a continuous variable, the collocation relevancy information indicates the collocation probability; here, the collocation relevancy information may be obtained through machine learning based on the combination frequency of a context and preliminary input candidate items in a word collocation database or other relevant databases. Based on the collocation relevancy information, by performing screening or ordering processing to the one or more preliminary input candidate items, the one or more input candidate items are obtained.

More preferably, the input device further comprises a text processing module (not shown) and an establishing module (not shown); wherein, the text processing module performs analysis processing to one or more pieces of text information to obtain a word segmentation collocation relationship whose collocation frequency satisfies a certain threshold; the establishing module establishes or updates the word collocation database based on the word segmentation collocation relationship. Specifically, the text processing module obtains various logs or various articles, and performs an analysis method, for example, first performing word segmentation to the obtained text information, and then making statistics on the co-appearance frequency for neighboring words; when the co-appearance frequency exceeds a certain threshold, the text processing module judges that there is a certain collocation relationship between adjacent words, thereby obtaining a word segmentation collocation relationship whose collocation frequency satisfies a certain threshold; the establishing module establishes the word collocation database based on the word segmentation collocation relationship, or updates the existing word collocation database, etc. Here, the word collocation database includes, but not limited to, collocation probability information between word segmentation collocation relationship and word segmentation collocation relationship; besides, the word collocation database likely comprises existing fixed words, e.g., idioms, proverbs, etc.; and meanwhile, through the update, the new words and expressions generated with rapid development of the existing network applications may be included therein, thereby effectively enhancing the user's input efficiency.

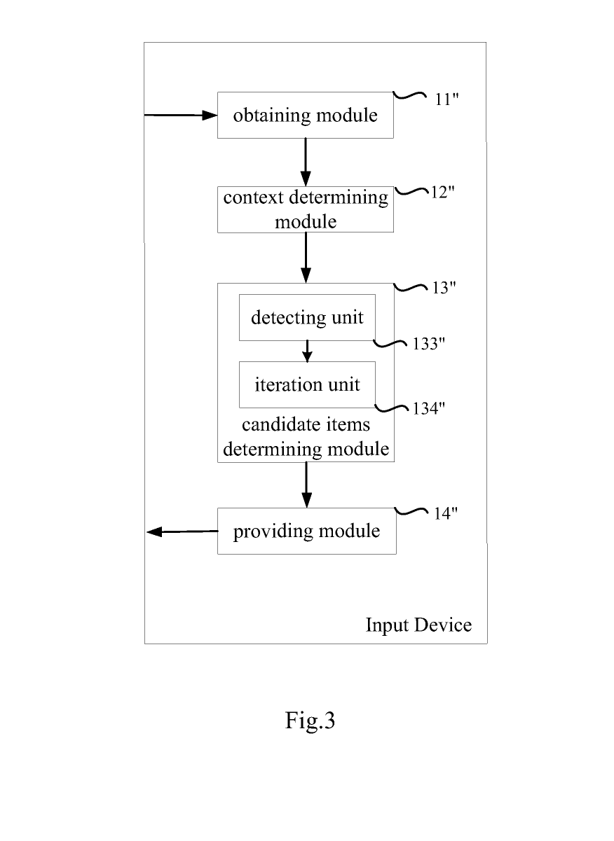

FIG. 3 shows a schematic diagram of the input device for providing input candidate items corresponding to an input character string according to another preferred embodiment of the present invention; wherein, the input device comprises an obtaining module 11″, a context determining module 12″, a candidate items determining module 13″, a providing module 14″; here, the candidate items determining module 13″ comprises a detecting unit 133″ and an iteration unit 134″. Specifically, the obtaining module 11″ obtains an input character string; the context determining module 12″ determines context information of the input character string; the detecting unit 133″ detects whether the input character string has exceeded a predetermined length threshold; if the input character string exceeds the length threshold, the iteration unit 134″ iteratively determines one or more input candidate items corresponding to the input character string based on the input character string and the context information; the providing module 14″ provides at least one of the one or more input candidate items to a target application corresponding to the input character string. Herein, the obtaining module 11″, the context determining module 12″, the providing module 14″ are identical or substantially identical to corresponding modules shown in FIG. 1, which are thus not detailed here, but incorporated here by reference.

The above modules work constantly therebetween. Here, those skilled in the art should understand that “constantly” means the above various modules perform obtaining an input character string, determining context information, detecting a length threshold, determining input candidate items, providing input candidate items and etc. respectively in real-time or according a preset or real-time adjusted working pattern requirements, until the input device stops obtaining an input character string.

The detecting unit 133″ detects whether the input character string has exceeded a predetermined length threshold. Specifically, the detecting unit 133″ detects a length of the input character string based on a preset length threshold or a length threshold set by the user itself, to detect whether the length of the input character string has exceeded the predetermined length threshold. For example, when the predetermined character length threshold is N, and when the length of the input character string is N+1, then the detecting unit 133″ detects that the input character string has exceeded the predetermined length threshold.

If the input character string exceeds the length threshold, the iteration unit 134″ iteratively determines one or more input candidate items corresponding to the input character string based on the input character string and the context information. Specifically, if the input character string has exceeded the length threshold, the iteration unit 134″ determines the input candidate items corresponding to an input character string within the first length threshold based on the input character string and the context information through performing segmentation and other processing to the input character string based on the length threshold, and re-uses the determined input candidate items as the context information, thereby determining one or more input candidate items corresponding to the input character string by the means of iteratively determining the input candidate items corresponding to the input character string within the next length threshold.

Preferably, the detecting unit 133″ may obtain one or more sample input candidate items corresponding to the input character string in an input lexicon; detect whether the number of words of at least one of the one or more sample input candidate items has exceeded a predetermined threshold of the number of words, to determine whether the input character string exceeds a predetermined length threshold. Specifically, the detecting unit 133″ may also obtain one or more input candidate items corresponding to the entire input character string through, for example, directly matching the input character string in the input lexicon, and then, through random extraction or designated extraction (e.g., selecting the first input candidate item, etc.), obtain one or more sample input candidate items corresponding to the input character string in the input lexicon; and finally, determine whether the input character string has exceeded a predetermined length threshold through detecting the one or more sample input candidate items, e.g., at least one of the sample input candidate items exceeds a predetermined word number threshold.

Preferably, the iteration unit 134″ may determine, based on the context information and a partial input character string adjacent to the context information in the input character string, one or more partial input candidate items corresponding to the partial input character string when the input character string exceeds the length threshold; determine, based on the partial input character string and a remaining input character string in the input character string, one or more remaining input candidate items corresponding to the remaining input character string, wherein the partial input candidate items are used as context information of the remaining input character string; determine the one or more input candidate items based on the one or more partial input candidate items and the one or more remaining input candidate items.

Specifically, when the input character string exceeds the length threshold, the input character string is subject to word segmentation or paragraph segmentation and the like based on the context information, thereby obtaining a part of input character strings adjacent to the context information in the input character string, and determines one or more partial input candidate items corresponding to the partial input character string by combining the partial input character string with the context information; here, the determining method is identical or similar to the determining method in the candidate items determining module 13 in FIG. 1, which will not be detailed here, but is incorporated here by reference. The iteration unit 134″ iteratively determines one or more remaining input candidate items corresponding to the remaining input character string using the partial input candidate item as the context information of the remaining input character string; after iteration, the partial input candidate items and the remaining input candidate items are joined and the like to determine one or more input candidate items based on for example the relationships between these character strings.

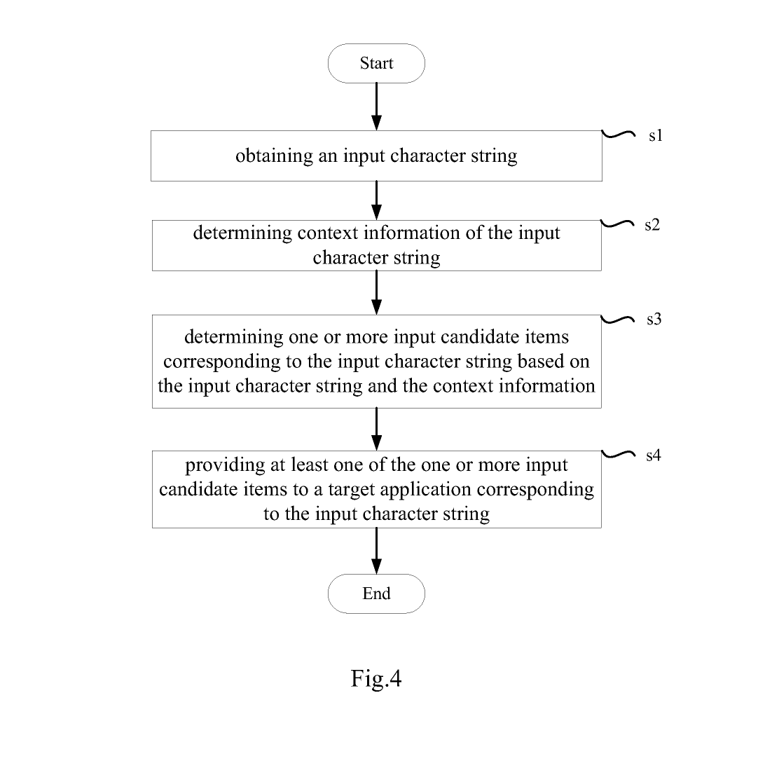

FIG. 4 shows a flow diagram of a method for providing input candidate items corresponding to an input character string according to another aspect of the present invention. Specifically, in the step s1, the input device obtains an input character string; in the step s2, the input device determines context information of the input character string; in the step s3, the input device determines one or more input candidate items corresponding to the input character string based on the input character string and the context information; in the step s4, the input device provides at least one of the one or more input candidate items to a target application corresponding to the input character string.

The above steps work constantly therebetween. Here, those skilled in the art should understand that “constantly” means the above various steps perform obtaining an input character string, determining context information, determining input candidate items, providing input candidate items and etc. respectively in real-time or according a preset or real-time adjusted working pattern requirements, until the input device stops obtaining an input character string.

In the step s1, the input device obtains an input character string. Specifically, in the step s1, the input device receives a character string inputted by the user or other applications through operations such as input, select, click and the like from the input box; or based on various communication protocols via various data transmission interfaces, obtains a character string from within an input box of other applications; wherein the input box is such as an SMS editing box, content input box, etc. Here, the input character string includes, but not limited to, pinyin coded characters and the like inputted by full pinyin or simplified pinyin and the like.

In the step s2, the input device determines context information of the input character string. Specifically, in the step s2, the input device matches the words to which the current input character string belongs with one or more lexicons using the words to which the currently inputted character string belongs based on the input character string obtained by the step s1, and obtains one or more kind of matching information associated with the input character string as the context information of the input character string; for example, when inputting “huacao”, it is first determined that the words to which the input character string belongs are likely “ [symbol] (flower and grass),” and based on the matching information of “ [symbol] ” in the lexicon, it is determined that its context information could be “ [symbol] (tea),” and the like; or, in the step s2, the input device determines the context information of the input character string based on the historical record information corresponding to the input character string, e.g., the preceding input character string just displayed on the screen before the present input character string may be used as the previous context information of the input character string. Herein, the context information includes, but not limited to, preceding context information or subsequent context information corresponding to the input character string; for example, when the input is “shishi,” and when the phrase displayed on the screen for the preceding input is “ [symbol] (objective),” then the preceding context information corresponding to the “shishi” is “ [symbol] ”; if the screen presents a phrase “ [symbol] (plan)” and when “shishi” is input, the cursor is positioned before “ [symbol] ,” then the corresponding subsequent context information is “ [symbol] ”.

In the step s3, the input device determines one or more input candidate items corresponding to the input character string based on the input character string and the context information. Specifically, in the step s3, the input device determines one or more input candidate items corresponding to the input character by directly using one or more pieces of context information corresponding to the input character string as one or more input candidate items based on the input character string obtained by the step s1 and the context information determined by the step s2, or using the processed context information corresponding to the input character string as the input candidate items. For example, following the above example, when the input character string is “shishi”, its corresponding preceding context information could be “ [symbol] ”, “ [symbol] (I)”, “ [symbol] (discuss)”, etc.; when the preceding context information is “ [symbol] ”, it is determined that the input candidate items are “ [symbol] (fact)”, “ [symbol] (real-time)”, “ [symbol] (implement)”, and the like by the manner of matching the input character string and the context information matching; when the preceding context information is “ [symbol] ”, it is determined that the input candidate items are “ [symbol] (try)”, “ [symbol] [symbol] (implement)”, “ [symbol] (try)”, and the like; when the preceding context information is “ [symbol] (discuss)”, it is determined that the input candidate items are “ [symbol] (current events)”, “ [symbol] (facts)”, “ [symbol] (things of the world)”, and the like.

In the step s4, the input device provides at least one of the one or more input candidate items to a target application corresponding to the input character string. Specifically, in the step s4, the input device provides at least one of the one or more input candidate items to a target application corresponding to the input character string directly or based on various communication protocols with various data transfer interfaces through re-ordering or screening as an example, wherein the target application includes, but not limited to, the same application corresponding to an input box corresponding to the step s1, or other application associated with the input box corresponding to the step s1, e.g., performing search directly using the input candidate item, etc.

Preferably, in the step s3, the input device may determine a supplementary character string including the input character string based on the input character string and the context information, wherein the supplementary character string further comprises a character string corresponding to the context information; perform match query in an input lexicon based on the supplementary character string to obtain one or more supplementary input candidate items corresponding to the supplementary character string; and perform screening processing to the one or more supplementary input candidate items based on the context information to obtain the one or more input candidate items. Specifically, in the step s3, the input device may also determine a supplementary character string including the input character string based on the input character sting and the context information by matching the input character string in combination with the context information to for example the input lexicon. For example, when the input character string is “xuxu” and the context information is “ [symbol] (shape),” then it is determined that the supplementary character string is “rusheng”; or, when the input character string is “tianan” and the context information is “ [symbol] (Beijing),” then it is determined that the supplementary character string is “men.” Here, the supplementary character string includes, but not limited to, one or more multi-segment character strings formed by joining which determined by matching. In the step s3, the input device obtains one or more supplementary input candidate items corresponding to the supplemental character strings by performing a match query for the supplementary character string in the input lexicon. Following the above example, when the supplementary character string is “rusheng” and the corresponding supplementary input candidate items are, for example, “ [symbol] (ru sheng, vivid),” “ [symbol] (ru'sheng, the fourth tone in Chinese pronunciation),” “ [symbol] (ru'sheng, fascinating),” and the like; when the supplementary character string is “men,” the corresponding supplementary input candidate items are “ [symbol] (tian'an men),” [symbol] “(men, gate),” etc. Or, the supplementary input candidate item may also directly comprise the context information, e.g., directly generating “ [symbol] (the shape is vivid),” “ [symbol] [symbol] (Beijing Tian'an Men),” and the like. Based on the context information, the one or more supplementary input candidate items are subject to screening processing. Following the above example, based on the context information, the input candidate items are determined to “ [symbol] ,” “ [symbol] ” respectively, thereby obtaining one or more input candidate items; here, if the supplementary input candidate items comprise context information, then after the context information in the supplementary input candidate item is deleted, one or more input candidate items are obtained. For example, if “ [symbol] ” in the supplementary input candidate item “ [symbol] ” is deleted, one or more input candidate items, i.e., “ [symbol] ,” are obtained.

Preferably, in the step s2, the input device may extract a corresponding focal word as the context from a relevancy text by performing natural language processing to the relevancy text corresponding to the input character string, wherein the focal word is adjacent to an input position corresponding to the input character string. Specifically, in the step s2, the input device may also perform natural language processing to relevant text corresponding to the input character string by segmentation or semantic analysis, wherein the relevant text includes, but not limited to, the text corresponding to the input character string per se, or relevant text that has been displayed on the screen before/after the input position corresponding to the input character string; by performing natural language processing to the relevant text, corresponding focal words are extracted as the context. For example, when the input character string is “shishi”, its corresponding relevant text is “ [symbol] (Shanghai metro first-stage project)”, and the input character string is located after “ [symbol] ”, and by performing natural language processing to the relevant text, the focal word as extracted is “ [symbol] (project)”, which is used as the context. Further, when the input character string is “shishi”, the input device determines, based on the context “project”, that the input candidate items are “ [symbol] [symbol] (shishi, implement)”, “ [symbol] (shishi, real-time)”, and “ [symbol] (shishi, try)”, etc.

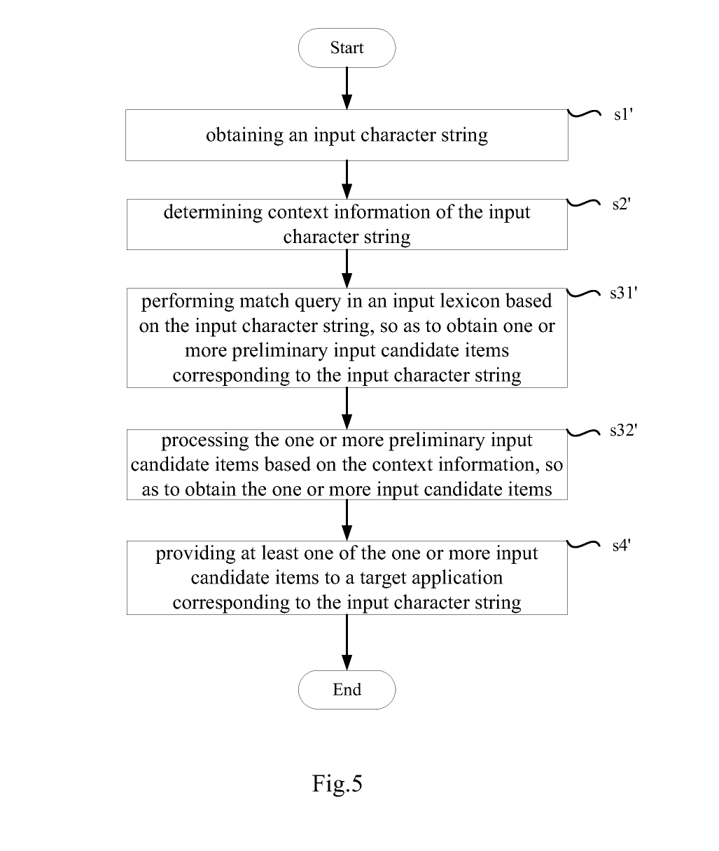

FIG. 5 shows a flow diagram of a method for providing input candidate items corresponding to an input character string according to one preferred embodiment of the present invention. Specifically, in the step s1′, the input device obtains an input character string; in the step s2′, the input device determines context information of the input character string; in the step s31′, the input device performs match query in an input lexicon based on the input character string, so as to obtain one or more preliminary input candidate items corresponding to the input character string; in the step s32′, the input device processes the one or more preliminary input candidate items based on the context information, so as to obtain the one or more input candidate items; in the step s4′, the input device provides at least one of the one or more input candidate items to a target application corresponding to the input character string. Herein, the step s1′, the step s2′, the step s4′ are identical or substantially identical to corresponding steps shown in FIG. 4, which are thus not detailed here, but incorporated here by reference.

The above steps work constantly therebetween. Here, those skilled in the art should understand that “constantly” means the above various steps perform obtaining an input character string, determining context information, obtaining preliminary input candidate items, determining input candidate items, providing input candidate items and etc. respectively in real-time or according a preset or real-time adjusted working pattern requirements, until the input device stops obtaining an input character string.

In the step s31′, the input device performs match query in an input lexicon based on the input character string, so as to obtain one or more preliminary input candidate items corresponding to the input character string. Specifically, in the step s31′, the input device matches the input character string with words in the input lexicon by obtaining the input character string, so as to obtain one or more preliminary input candidate items corresponding to the input character string. For example, when the input character string is “shishi”, after performing match query in the input lexicon, a plurality of preliminary input candidate items such as “ [symbol] (shishi, real-time)”, “ [symbol] (shishi, try)”, “ [symbol] (shishi, implement)”, “ [symbol] (shishi, fact)”, “ [symbol] (shishi, at appropriate time)”, “ [symbol] (shishi, deceased)”, and etc. are obtained.

In the step s32′, the input device processes the one or more preliminary input candidate items based on the context information, so as to obtain the one or more input candidate items. Specifically, in the step s32′, the input device determines a collocation probability between the context information and the preliminary input candidate items based on the context information of the input character string through a natural language model or a word collocation database, etc., and performing screening or ordering to the preliminary input candidate items based on the collocation probability, to obtain the input candidate items. For example, following the above example, when the context information is “ [symbol] (objective)”, then after processing, through reordering the preliminary input candidate items, the order changes to be “ [symbol] (shishi, fact)”, “ [symbol] (shishi, real-time)”, “ [symbol] (shishi, try)”, “ [symbol] (shishi, implement)”, “ [symbol] (shishi, at appropriate time)”, “ [symbol] (shishi, deceased)”, and etc.

Preferably, in the step s32′, the input device may perform match query in a word collocation database based on the context information to determine collocation relevancy information between the preliminary input candidate items and the corresponding context information; and process the one or more preliminary input candidate items based on the collocation relevancy information to obtain the one or more input candidate items. Specifically, in the step s32′, the input device may also perform matching query in the word collocation database based on the context information, to determine the collocation relevancy information between the preliminary input candidate items and the corresponding context information based on the matching relationship between the one or more entries in the word collocation database and the context; for example, if it is a bull variable, then the collocation relevancy information indicates if a collocation exists; if it is a continuous variable, the collocation relevancy information indicates the collocation probability; here, the collocation relevancy information may be obtained through machine learning based on the combination frequency of a context and preliminary input candidate items in a word collocation database or other relevant databases. Based on the collocation relevancy information, by performing screening or ordering processing to the one or more preliminary input candidate items, the one or more input candidate items are obtained.

More preferably, the method further comprises a step s5′ (not shown) and a step s6′ (not shown); wherein, in the step s5′, the input device performs analysis processing to one or more pieces of text information to obtain a word segmentation collocation relationship whose collocation frequency satisfies a certain threshold; in the step s6′, the input device establishes or updates the word collocation database based on the word segmentation collocation relationship. Specifically, in the step s5′, the input device obtains various logs or various articles, and performs an analysis method, for example, first performing word segmentation to the obtained text information, and then making statistics on the co-appearance frequency for neighboring words; when the co-appearance frequency exceeds a certain threshold, in the step s5′, the input device judges that there is a certain collocation relationship between adjacent words, thereby obtaining a word segmentation collocation relationship whose collocation frequency satisfies a certain threshold; in the step s6′, the input device establishes the word collocation database based on the word segmentation collocation relationship, or updates the existing word collocation database, etc. Here, the word collocation database includes, but not limited to, collocation probability information between word segmentation collocation relationship and word segmentation collocation relationship; besides, the word collocation database likely comprises existing fixed words, e.g., idioms, proverbs, etc.; and meanwhile, through the update, the new words and expressions generated with rapid development of the existing network applications may be included therein, thereby effectively enhancing the user's input efficiency.

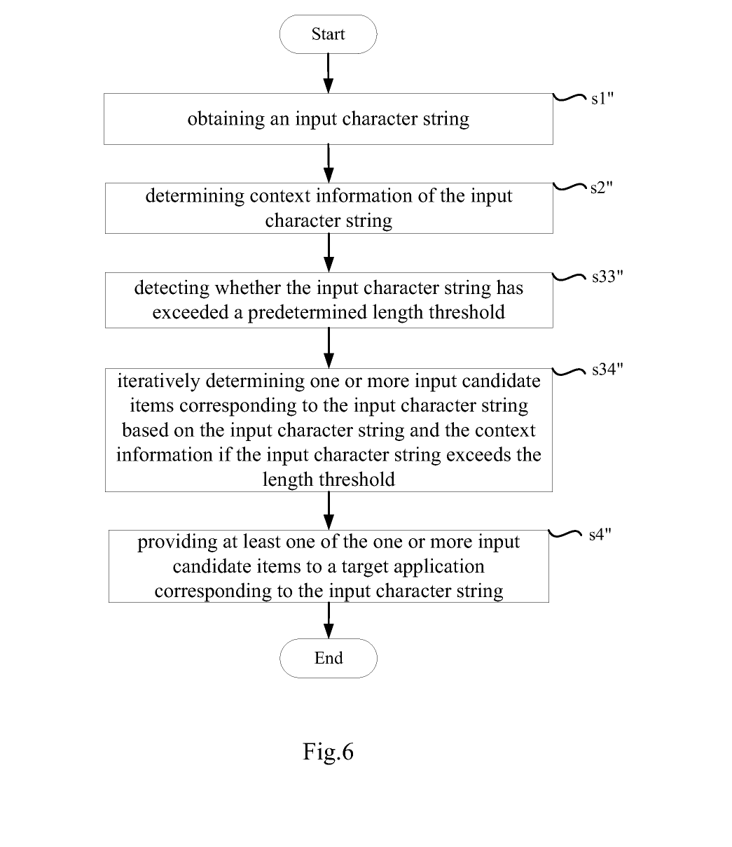

FIG. 6 shows a flow diagram of a method for providing input candidate items corresponding to an input character string according to another preferred embodiment of the present invention. Specifically, in the step s1″, the input device obtains an input character string; in the step s2″, the input device determines context information of the input character string; in the step s33″, the input device detects whether the input character string has exceeded a predetermined length threshold; if the input character string exceeds the length threshold, in the step s34″, the input device iteratively determines one or more input candidate items corresponding to the input character string based on the input character string and the context information; in the step s4″, the input device provides at least one of the one or more input candidate items to a target application corresponding to the input character string. Herein, the step s1″, the step s2″, the step s4″ are identical or substantially identical to corresponding steps shown in FIG. 4, which are thus not detailed here, but incorporated here by reference.

The above steps work constantly therebetween. Here, those skilled in the art should understand that “constantly” means the above various steps perform obtaining an input character string, determining context information, detecting a length threshold, determining input candidate items, providing input candidate items and etc. respectively in real-time or according a preset or real-time adjusted working pattern requirements, until the input device stops obtaining an input character string.

In the step s33″, the input device detects whether the input character string has exceeded a predetermined length threshold. Specifically, in the step s33″, the input device detects a length of the input character string based on a preset length threshold or a length threshold set by the user itself, to detect whether the length of the input character string has exceeded the predetermined length threshold. For example, when the predetermined character length threshold is N, and when the length of the input character string is N+1, then in the step s33″, the input device detects that the input character string has exceeded the predetermined length threshold.

If the input character string exceeds the length threshold, in the step s34″, the input device iteratively determines one or more input candidate items corresponding to the input character string based on the input character string and the context information. Specifically, if the input character string has exceeded the length threshold, in the step s34″, the input device determines the input candidate items corresponding to an input character string within the first length threshold based on the input character string and the context information through performing segmentation and other processing to the input character string based on the length threshold, and re-uses the determined input candidate items as the context information, thereby determining one or more input candidate items corresponding to the input character string by the means of iteratively determining the input candidate items corresponding to the input character string within the next length threshold.

Preferably, in the step s33″, the input device may obtain one or more sample input candidate items corresponding to the input character string in an input lexicon; detect whether the number of words of at least one of the one or more sample input candidate items has exceeded a predetermined threshold of the number of words, to determine whether the input character string exceeds a predetermined length threshold. Specifically, in the step s33″, the input device may also obtain one or more input candidate items corresponding to the entire input character string through, for example, directly matching the input character string in the input lexicon, and then, through random extraction or designated extraction (e.g., selecting the first input candidate item, etc.), obtain one or more sample input candidate items corresponding to the input character string in the input lexicon; and finally, determine whether the input character string has exceeded a predetermined length threshold through detecting the one or more sample input candidate items, e.g., at least one of the sample input candidate items exceeds a predetermined word number threshold.

Preferably, in the step s34″, the input device may determine, based on the context information and a partial input character string adjacent to the context information in the input character string, one or more partial input candidate items corresponding to the partial input character string when the input character string exceeds the length threshold; determine, based on the partial input character string and a remaining input character string in the input character string, one or more remaining input candidate items corresponding to the remaining input character string, wherein the partial input candidate items are used as context information of the remaining input character string; determine the one or more input candidate items based on the one or more partial input candidate items and the one or more remaining input candidate items.

Specifically, when the input character string exceeds the length threshold, the input character string is subject to word segmentation or paragraph segmentation and the like based on the context information, thereby obtaining a part of input character strings adjacent to the context information in the input character string, and determines one or more partial input candidate items corresponding to the partial input character string by combining the partial input character string with the context information; here, the determining method is identical or similar to the determining method in the step s3 in FIG. 4, which will not be detailed here, but is incorporated here by reference. In the step s34″, the input device iteratively determines one or more remaining input candidate items corresponding to the remaining input character string using the partial input candidate item as the context information of the remaining input character string; after iteration, the partial input candidate items and the remaining input candidate items are joined and the like to determine one or more input candidate items based on for example the relationships between these character strings.

Aspects of various embodiments are specified in the claims. Those and other aspects of various embodiments are specified in the following numbered clauses:

1. A method for providing input candidate items corresponding to an input character string, wherein the method comprises the following steps:

a. obtaining an input character string;

b. determining context information of the input character string;

c. determining one or more input candidate items corresponding to the input character string based on the input character string and the context information;

d. providing at least one of the one or more input candidate items to a target application corresponding to the input character string.

2. The method of clause 1, wherein the step c comprises:
performing match query in an input lexicon based on the input character string, so as to obtain one or more preliminary input candidate items corresponding to the input character string;

c1. processing the one or more preliminary input candidate items based on the context information, so as to obtain the one or more input candidate items.

3. The method of clause 2, wherein the step c1 comprises:
performing match query in a word collocation database based on the context information to determine collocation relevancy information between the preliminary input candidate items and the corresponding context information;
processing the one or more preliminary input candidate items based on the collocation relevancy information to obtain the one or more input candidate items.

4. The method of clause 3, wherein the method further comprises:
performing analysis processing to one or more pieces of text information to obtain a word segmentation collocation relationship whose collocation frequency satisfies a certain threshold;
establishing or updating the word collocation database based on the word segmentation collocation relationship.

5. The method of clause 1, wherein the step c comprises:
determining a supplementary character string including the input character string based on the input character string and the context information, wherein the supplementary character string further comprises a character string corresponding to the context information;
performing match query in an input lexicon based on the supplementary character string to obtain one or more supplementary input candidate items corresponding to the supplementary character string;
performing screening processing to the one or more supplementary input candidate items based on the context information to obtain the one or more input candidate items.

6. The method of any one of clauses 1 to 5, wherein the step b comprises:
extracting a corresponding focal word as the context from a relevancy text by performing natural language processing to the relevancy text corresponding to the input character string, wherein the focal word is adjacent to an input position corresponding to the input character string.

7. The method of any one of clauses 1 to 6, wherein the step c comprises:

c2. detecting whether the input character string has exceeded a predetermined length threshold;

c3. iteratively determining one or more input candidate items corresponding to the input character string based on the input character string and the context information if the input character string exceeds the length threshold.

8. The method of clause 7, wherein the step c2 comprises:
obtaining one or more sample input candidate items corresponding to the input character string in an input lexicon;
detecting whether the number of words of at least one of the one or more sample input candidate items has exceeded a predetermined threshold of the number of words, to determine whether the input character string exceeds a predetermined length threshold.

9. The method of clause 7 or 8, wherein the step c3 comprises:
determining, based on the context information and a partial input character string adjacent to the context information in the input character string, one or more partial input candidate items corresponding to the partial input character string when the input character string exceeds the length threshold;
determining, based on the partial input character string and a remaining input character string in the input character string, one or more remaining input candidate items corresponding to the remaining input character string, wherein the partial input candidate items are used as context information of the remaining input character string;
determining the one or more input candidate items based on the one or more partial input candidate items and the one or more remaining input candidate items.

10. An input device for providing input candidate items corresponding to an input character string, wherein the device comprises:

an obtaining module configured to obtain an input character string;

a context determining module configured to determine context information of the input character string;

a candidate items determining module configured to determine one or more input candidate items corresponding to the input character string based on the input character string and the context information;

a providing module configured to provide at least one of the one or more input candidate items to a target application corresponding to the input character string.

11. The input device of clause 10, wherein the candidate items determining module comprises:

a matching unit configured to perform match query in an input lexicon based on the input character string, so as to obtain one or more preliminary input candidate items corresponding to the input character string;

a processing unit configured to process the one or more preliminary input candidate items based on the context information, so as to obtain the one or more input candidate items.

12. The input device of clause 11, wherein the processing unit is configured to:
perform match query in a word collocation database based on the context information to determine collocation relevancy information between the preliminary input candidate items and the corresponding context information;
process the one or more preliminary input candidate items based on the collocation relevancy information to obtain the one or more input candidate items.

13. The input device of clause 12, wherein the device further comprises:

a text processing module configured to perform analysis processing to one or more pieces of text information to obtain a word segmentation collocation relationship whose collocation frequency satisfies a certain threshold;

an establishing module configured to establish or update the word collocation database based on the word segmentation collocation relationship.

14. The input device of clause 10, wherein the candidate items determining module is configured to:
determine a supplementary character string including the input character string based on the input character string and the context information, wherein the supplementary character string further comprises a character string corresponding to the context information;
perform match query in an input lexicon based on the supplementary character string to obtain one or more supplementary input candidate items corresponding to the supplementary character string;
perform screening processing to the one or more supplementary input candidate items based on the context information to obtain the one or more input candidate items.

15. The input device of any one of clauses 10 to 14, wherein the context determining module is configured to:
extract a corresponding focal word as the context from a relevancy text by performing natural language processing to the relevancy text corresponding to the input character string, wherein the focal word is adjacent to an input position corresponding to the input character string.

16. The input device of any one of clauses 10 to 15, wherein the candidate items determining module comprises:

a detecting unit configured to detect whether the input character string has exceeded a predetermined length threshold;

an iteration unit configured to iteratively determine one or more input candidate items corresponding to the input character string based on the input character string and the context information if the input character string exceeds the length threshold.

17. The input device of clause 16, wherein the detecting unit is configured to:
obtain one or more sample input candidate items corresponding to the input character string in an input lexicon;
detect whether the number of words of at least one of the one or more sample input candidate items has exceeded a predetermined threshold of the number of words, to determine whether the input character string exceeds a predetermined length threshold.

18. The input device of clause 16 or 17, wherein the iteration unit is configured to:
determine, based on the context information and a partial input character string adjacent to the context information in the input character string, one or more partial input candidate items corresponding to the partial input character string when the input character string exceeds the length threshold;
determine, based on the partial input character string and a remaining input character string in the input character string, one or more remaining input candidate items corresponding to the remaining input character string, wherein the partial input candidate items are used as context information of the remaining input character string;
determine the one or more input candidate items based on the one or more partial input candidate items and the one or more remaining input candidate items.

To those skilled in the art, apparently the present invention is not limited to the details of the aforementioned exemplary embodiments; moreover, under the premise of not deviating from the spirit or fundamental characteristics of the invention, this invention can be accomplished in other specific forms. Therefore, the embodiments should be considered exemplary and non-restrictive no matter from which point, the scope of the invention is defined by the appended claims instead of the above description, and aims at covering the meanings of the equivalent components falling into the claims and all changes within the scope in this invention. Any reference sign in the claims shall not be deemed as limiting the concerned claims. Besides, apparently the word “comprise/include” does not exclude other components or steps, singular numbers does not exclude complex numbers, the plurality of components or means mentioned in device claims may also be accomplished by one component or means through software or hardware, the wording like first and second are only used to represent names rather than any specific order.

1-18. (canceled)

19. A method for providing input candidate items corresponding to an input character string, said method comprising obtaining an input character string, determining context information of the input character string, determining one or more input candidate items corresponding to the input character string based on the input character string and the context information, and providing at least one of the one or more input candidate items to a target application corresponding to the input character string.

20. The method of claim 19, wherein determining one or more input candidate items corresponding to the input character string based on the input character string and the context information comprises performing match query in an input lexicon based on the input character string, so as to obtain one or more preliminary input candidate items corresponding to the input character string, and processing the one or more preliminary input candidate items based on the context information so as to obtain the one or more input candidate items.

21. The method of claim 20, wherein processing the one or more preliminary input candidate items based on the context information so as to obtain the one or more input candidate items comprises performing a match query in a word collocation database based on the context information to determine collocation relevancy information between the preliminary input candidate items and the corresponding context information, and processing the one or more preliminary input candidate items based on the collocation relevancy information to obtain the one or more input candidate items.

22. The method of claim 21, wherein the method further comprises performing analysis processing to one or more pieces of text information to obtain a word segmentation collocation relationship whose collocation frequency satisfies a certain threshold, and establishing or updating the word collocation database based on the word segmentation collocation relationship.

23. The method of claim 19, wherein determining one or more input candidate items corresponding to the input character string based on the input character string and the context information comprises determining a supplementary character string including the input character string based on the input character string and the context information, wherein the supplementary character string further comprises a character string corresponding to the context information, performing match query in an input lexicon based on the supplementary character string to obtain one or more supplementary input candidate items corresponding to the supplementary character string, and performing screening processing to the one or more supplementary input candidate items based on the context information to obtain the one or more input candidate items.

24. The method of claim 19, wherein determining context information of the input character string comprises extracting a corresponding focal word as the context from a relevancy text by performing natural language processing to the relevancy text corresponding to the input character string, wherein the focal word is adjacent to an input position corresponding to the input character string.

25. The method of claim 19, wherein determining one or more input candidate items corresponding to the input character string based on the input character string and the context information comprises detecting whether the input character string has exceeded a predetermined length threshold, and iteratively determining one or more input candidate items corresponding to the input character string based on the input character string and the context information if the input character string exceeds the length threshold.

26. The method of claim 25, wherein detecting whether the input character string has exceeded a predetermined length threshold comprises obtaining one or more sample input candidate items corresponding to the input character string in an input lexicon, and detecting whether the number of words of at least one of the one or more sample input candidate items has exceeded a predetermined threshold of the number of words, to determine whether the input character string exceeds a predetermined length threshold.

27. The method of claim 25, wherein iteratively determining one or more input candidate items corresponding to the input character string based on the input character string and the context information if the input character string exceeds the length threshold comprises determining, based on the context information and a partial input character string adjacent to the context information in the input character string, one or more partial input candidate items corresponding to the partial input character string when the input character string exceeds the length threshold, determining, based on the partial input character string and a remaining input character string in the input character string, one or more remaining input candidate items corresponding to the remaining input character string, wherein the partial input candidate items are used as context information of the remaining input character string, and determining the one or more input candidate items based on the one or more partial input candidate items and the one or more remaining input candidate items.

28. An apparatus comprising an input device for providing input candidate items corresponding to an input character string, wherein the device comprises an obtaining module configured to obtain an input character string, a context determining module configured to determine context information of the input character string, a candidate items determining module configured to determine one or more input candidate items corresponding to the input character string based on the input character string and the context information, and a providing module configured to provide at least one of the one or more input candidate items to a target application corresponding to the input character string.

29. The apparatus of claim 28, wherein the candidate items determining module comprises a matching unit configured to perform match query in an input lexicon based on the input character string, so as to obtain one or more preliminary input candidate items corresponding to the input character string, and a processing unit configured to process the one or more preliminary input candidate items based on the context information, so as to obtain the one or more input candidate items.

30. The apparatus of claim 29, wherein the processing unit is configured to perform match query in a word collocation database based on the context information to determine collocation relevancy information between the preliminary input candidate items and the corresponding context information, and to process the one or more preliminary input candidate items based on the collocation relevancy information to obtain the one or more input candidate items.

31. The apparatus of claim 30, wherein the device further comprises a text processing module configured to perform analysis processing to one or more pieces of text information to obtain a word segmentation collocation relationship whose collocation frequency satisfies a certain threshold, and an establishing module configured to establish or update the word collocation database based on the word segmentation collocation relationship.

32. The apparatus of claim 28, wherein the candidate items determining module is configured to determine a supplementary character string including the input character string based on the input character string and the context information, wherein the supplementary character string further comprises a character string corresponding to the context information, perform match query in an input lexicon based on the supplementary character string to obtain one or more supplementary input candidate items corresponding to the supplementary character string, and perform screening processing to the one or more supplementary input candidate items based on the context information to obtain the one or more input candidate items.

33. The apparatus of claim 28, wherein the context determining module is configured to extract a corresponding focal word as the context from a relevancy text by performing natural language processing to the relevancy text corresponding to the input character string, wherein the focal word is adjacent to an input position corresponding to the input character string.

34. The apparatus of claim 28, wherein the candidate items determining module comprises a detecting unit configured to detect whether the input character string has exceeded a predetermined length threshold, and an iteration unit configured to iteratively determine one or more input candidate items corresponding to the input character string based on the input character string and the context information if the input character string exceeds the length threshold.

35. The apparatus of claim 34, wherein the detecting unit is configured to obtain one or more sample input candidate items corresponding to the input character string in an input lexicon, to detect whether the number of words of at least one of the one or more sample input candidate items has exceeded a predetermined threshold of the number of words, and to determine whether the input character string exceeds a predetermined length threshold.

36. The apparatus of claim 34, wherein the iteration unit is configured to determine, based on the context information and a partial input character string adjacent to the context information in the input character string, one or more partial input candidate items corresponding to the partial input character string when the input character string exceeds the length threshold, to determine, based on the partial input character string and a remaining input character string in the input character string, one or more remaining input candidate items corresponding to the remaining input character string, wherein the partial input candidate items are used as context information of the remaining input character string, and to determine the one or more input candidate items based on the one or more partial input candidate items and the one or more remaining input candidate items.

37. A manufacture comprising a non-transitory computer readable storage medium having encoded thereon computer code, then, when executed, causes execution of the method of claim 19.
